(19) United States
(12) Patent Application Publication
(10) Pub. No.: US 2019/0218357 A1
(43) Pub. Date: Jul. 18, 2019

(54) COMPOSITION FOR MOLDED FOAM AND METHOD FOR PRODUCING SAME, MOLDED FOAM AND METHOD FOR PRODUCING SAME, AND MODIFIED CELLULOSE-CONTAINING RESIN COMPOSITION FOR MOLDED FOAM

(71) Applicant: SEIKO PMC CORPORATION, Tokyo (JP)

(72) Inventors: Shuhei YAMADA, Chiba (JP); Yukino YANAGIBORI, Chiba (JP); Syuichi OHIRA, Chiba (JP); Daisuke KUROKI, Chiba (JP)

(21) Appl. No.: 16/307,027

(22) PCT Filed: Dec. 12, 2017
(86) PCT No.: PCT/JP2017/044616

§ 371 Date: Dec. 4, 2018

(30) Foreign Application Priority Data
Dec. 14, 2016 (JP) 2016-242515

(51) Int. Cl. C08J 9/10; C08J 9/00; C08L 1/02; C08K 5/14

(52) U.S. Cl. CPC C08J 9/102; C08J 2201/03; C08J 9/0085; C08L 1/02; C08K 5/14; C08J 9/104; C08J 9/107; C08J 9/106; C08J 2301/02; C08L 2203/12; C08L 2203/14; C08J 2300/22; C08J 2325/06; C08J 2333/06; C08J 2367/00; C08J 2323/02; C08J 2321/00; C08J 9/0023

(57) ABSTRACT

An object of the present invention is to provide a composition for a molded foam containing a peroxide and a blowing agent, in which cellulose fibers are uniformly dispersed in a resin for a foam molding material having high hydrophobicity such as a thermoplastic resin and a rubber, and a foam excellent in mechanical properties which is obtained by reaction of the composition for a molded foam during foam molding. The composition for a molded foam contains a modified cellulose fiber (A) having an unsaturated bond, a thermoplastic resin and/or a rubber (B), a peroxide (C), and a blowing agent (D).

### TECHNICAL FIELD

The present invention relates to a composition for a molded foam and a method for producing the same, the molded foam using the composition for the molded foam and a method for producing the same, and a modified cellulose-containing resin composition for the molded foam.

### BACKGROUND ART

Resins for foam molding materials such as polyethylene and polypropylene are widely used for containers, piping, films, medical applications and the like from a viewpoint that they are inexpensive and excellent in flexibility and chemical resistance. In addition, in order to impart weight reduction, heat insulation, and impact absorption properties, a foam obtained by foaming the resin for the foam molding material is conventionally known. The foam of the resin for the foam molding material has the same volume and light weight as compared with an unfoamed state, and is excellent in heat insulation and impact absorption properties, but on the other hand, there is a problem that mechanical properties deteriorate as an expansion ratio is increased. In order to improve the mechanical properties of the resin for the foam molding material, a reinforcing material such as a filler is blended.

For example, in Patent Literature 1, by using carbon fiber or glass fiber as a filler, a reinforcing effect is obtained to improve the mechanical properties of the molded foam. However, since the carbon fiber is difficult to burn, it is unsuitable for thermal recycling and is expensive. Although the glass fiber is relatively inexpensive, there is a problem in disposal in thermal recycling.

On the other hand, microfibrillated cellulose obtained from vegetable fiber is relatively inexpensive and excellent in thermal recycling. In addition, since it has a strength or rigidity (modulus of elasticity) equal to or higher than that of steel with one fifth of weight of the steel, attention is paid as a reinforcing agent for the resin for the foam molding material. For example, Patent Literature 2 describes that hydrophobically modified cellulose fiber obtained by using polybasic acid anhydride as a hydrophobic modifier for a part of hydroxyl groups of the microfibrillated cellulose is used as the reinforcing material for the resin for the foam molding material.

Even when the above methods are used, the reinforcing effect is obtained to improve the mechanical properties of the molded foam, however, further improvement of the mechanical properties has been desired.

### CITATION LIST

### Patent Literature

Patent Literature 1: JP-A-2014-172915
Patent Literature 2: Japanese Patent No. 5865128 (JP-A-2013-185085)

### SUMMARY OF THE INVENTION

### Problems to be Solved by the Invention

An object of the present invention is to provide the composition for a molded foam containing a peroxide and a blowing agent, in which cellulose fibers are uniformly dispersed in the resin for the foam molding material having high hydrophobicity such as a thermoplastic resin and a rubber, and the foam excellent in mechanical properties obtained by reaction of the composition for a molded foam during foam molding.

### Solution to the Problems

As a result of extensive studies to solve the above problems, the present inventors have found that the molded foam excellent in mechanical properties can be obtained by foam molding in the presence of the peroxide and the blowing agent while uniformly mixing the modified cellulose fiber having an unsaturated bond with the resin for the foam molding material such as the thermoplastic resin or the rubber, and thus have completed the present invention. As another embodiment of the present invention, the present inventors have found that when using the modified cellulose-containing resin composition for the molded foam, in which the modified cellulose fiber having an unsaturated bond is a reaction product of a specific carboxyl group-containing modified cellulose and a compound having an unsaturated bond and a glycidyl group, even if a crosslinking agent other than a peroxide is used or the foam molding is carried out by another foaming method, it is possible to obtain the molded foam excellent in mechanical properties as in the above embodiment of the present invention.

That is, aspects of the present invention are as follows.

(1) A composition for a molded foam, containing a modified cellulose fiber (A) having an unsaturated bond, a thermoplastic resin and/or a rubber (B), a peroxide (C), and a blowing agent (D).
(2) The composition for a molded foam according to the above (1), in which the modified cellulose fiber (A) is a nanofibrillated material.
(3) The composition for a molded foam according to the above (1), in which the modified cellulose fiber (A) is a reaction product of a carboxyl group-containing modified cellulose (E) and a compound (F) having an unsaturated bond and a glycidyl group.
(4) The composition for a molded foam according to the above (3), in which the carboxyl group-containing modified cellulose (E) is a reaction product of cellulose and polybasic acid anhydride (G).
(5) The composition for a molded foam according to the above (4), in which the polybasic acid anhydride (G) is the polybasic acid anhydride having eight or more carbon atoms.
(6) The composition for a molded foam according to the above (1), in which the thermoplastic resin of the above (B) is at least one selected from polyolefin-based resin, polyester-based resin, acrylic resin and styrene resin.
(7) The composition for a molded foam according to the above (1), in which a mass ratio of the modified cellulose fiber (A)/the thermoplastic resin and/or the rubber (B)/the peroxide (C)/the blowing agent (D)=1 to 40/40 to 99/0.05 to 5/0.1 to 20.
(8) A molded foam using the composition for a molded foam according to any one of the above (1) to (7) as a raw material.
(9) A method for producing a composition for a molded foam, containing a modified cellulose fiber (A) having an unsaturated bond, a thermoplastic resin and/or a rubber (B), a peroxide (C), and a blowing agent (D), in which the modified cellulose fiber (A) having an unsaturated bond is obtained by reacting a carboxyl group-containing modified cellulose (E) with a compound (F) having an unsaturated bond and a glycidyl group.
(10) The method for producing a composition for a molded foam according to the above (9), in which the modified cellulose fiber (A) is a modified cellulose fiber obtained by reacting cellulose with polybasic acid anhydride (G) to obtain the carboxyl group-containing modified cellulose (E) and then further reacting the compound (F) having an unsaturated bond and a glycidyl group.
(11) The method for producing a composition for a molded foam according to the above (10), in which the polybasic acid anhydride (G) is the polybasic acid anhydride having eight or more carbon atoms.
(12) A method for producing a molded foam, in which a modified cellulose fiber (A) having an unsaturated bond and a thermoplastic resin and/or a rubber (B) are foam molded in the presence of a peroxide (C) and a blowing agent (D), so that the modified cellulose fiber (A) and the thermoplastic resin and/or the rubber (B) are reacted.
(13) The method for producing a molded foam according to the above (12), including the following steps,

(Step I) a step of heating and melt-kneading the modified cellulose fiber (A) and the thermoplastic resin and/or the rubber (B) to nanofibrillate the modified cellulose fiber (A),

(Step II) a step of adding the peroxide (C) and the blowing agent (D) after Step I, and

(Step III) a step of foam molding after Step II.

(14) A modified cellulose-containing resin composition for a molded foam, containing a modified cellulose fiber (A) having an unsaturated bond, and a thermoplastic resin and/or a rubber (B), in which the modified cellulose fiber (A) having an unsaturated bond is a reaction product of a carboxyl group-containing modified cellulose (E) and a compound (F) having an unsaturated bond and a glycidyl group, and the carboxyl group-containing modified cellulose (E) is a reaction product of cellulose and a polybasic acid anhydride (G) having eight or more carbon atoms.
(15) The modified cellulose-containing resin composition for the molded foam according to the above (14), in which the modified cellulose fiber (A) is a nanofibrillated material.
(16) The modified cellulose-containing resin composition for the molded foam according to the above (14), in which the thermoplastic resin is at least one selected from polyolefin-based resin, polyester-based resin, acrylic resin and styrene resin.
(17) The composition for a molded foam according to the above (14), in which a mass ratio of the modified cellulose fiber (A)/the thermoplastic resin and/or the rubber (B)=1 to 40/40 to 99.
(18) The molded foam using the modified cellulose-containing resin composition for the molded foam according to any one of the above (14) to (17) as a raw material.

### Effects of the Invention

It is possible to obtain a molded foam having high mechanical properties by foam molding the composition for a molded foam containing the modified cellulose fiber (A) having an unsaturated bond, the thermoplastic resin and/or the rubber (B), the peroxide (C) and the blowing agent (D) of the present invention. In addition, when using the modified cellulose-containing resin composition for the molded foam, which contains a specific modified cellulose fiber (A), and the thermoplastic resin and/or the rubber (B), the peroxide (C) and the blowing agent (D) are not always necessary, and the molded foam having high mechanical properties can be similarly obtained by any foaming method.

### DESCRIPTION OF THE EMBODIMENTS

Hereinafter, a composition for a molded foam and the method for producing the same, the molded foam and the method for producing the same according to the present invention will be described in detail.

### <Composition for Molded Foam>

The composition for a molded foam of the present invention contains a modified cellulose fiber (A) having an unsaturated bond, a thermoplastic resin and/or a rubber (B), a peroxide (C) and a blowing agent (D).

### <Modified Cellulose Fiber (A)>

The modified cellulose fiber (A) having an unsaturated bond used in the composition for a molded foam of the present invention is not particularly limited as long as the unsaturated bond is introduced, however, in view of improving mechanical properties, it is preferred that the unsaturated bond is introduced to such an extent that it can moderately have bonding points with a resin for a foam molding material (that is, such an extent that an improvement in mechanical properties is observed as compared with a case where the unsaturated bond is not introduced). It can be confirmed whether the unsaturated bond is introduced into the cellulose fiber by iodine value measurement. As a preferable degree of the unsaturated bond, an iodine value of the modified cellulose fiber (A) is 5 to 130, and preferably 20 to 50.

The iodine value can be measured by the following procedure. After allowing a sample to swell in N-methylpyrrolidone (hereinafter referred to as NMP in some cases), add an iodine monochloride solution and leave it in the dark. After potassium iodide and water are added, titration is carried out with sodium thiosulfate solution. At a stage when a color of the solution became pale yellow, the iodine value can be determined by adding a starch solution and titration until a blue color disappears. Specifically, it is determined according to a method used in Examples.

The modified cellulose fiber (A) having an unsaturated bond is preferably a nanofibrillated material (microfibrillated cellulose). Since it is sufficient if it is sufficiently microfibrillated in the foam molding material after mixing, it is not necessarily required that it is microfibrillated before mixing. An average value of fiber diameter of the microfibrillated cellulose is usually 4 to 800 nm, preferably 10 to 550 nm, and more preferably 20 to 400 nm.

Raw materials of the cellulose fiber used for obtaining the modified cellulose fiber (A) include plant-derived fibers (hereinafter referred to as plant fiber) included in wood, bamboo, hemp, jute, kenaf, cotton, beet and the like. Preferred plant fibers include wood, for example, pine, cedar, cypress, eucalyptus, acacia and the like, and paper obtained from these as the raw materials, waste paper or the like can also be used. One type of the plant fibers may be used alone, or two or more types selected from these may be used. The cellulose fibers include, for example, a pulp obtained from the plant fiber-containing material and a cellulose fiber subjected to mercerization, and may include regenerated cellulose fibers such as rayon, cellophane, lyocell and the like.

The pulps include a chemical pulp (unbleached kraft pulp (UKP), bleached kraft pulp (BKP), sulfite pulp (SP)), semi-chemical pulp (SCP), chemi-ground pulp (CGP), chemi-mechanical pulp (CMP), groundwood pulp (GP), refiner mechanical pulp (RMP), thermomechanical pulp (TMP), chemi-thermomechanical pulp (CTMP) and the like, which are obtained by pulping the plant fiber chemically, mechanically, or chemically and mechanically. Among these pulps, various kraft pulps derived from coniferous trees having strong fiber strength are particularly preferable. The cellulose fiber in the present invention may contain other components such as hemicellulose and lignin.

A method for introducing the unsaturated bond into the cellulose fiber when producing the modified cellulose fiber (A) having an unsaturated bond is not particularly limited. For example, there is a method for introducing the unsaturated bond by reacting a polybasic acid anhydride having an unsaturated bond, an isocyanate compound having an unsaturated bond, or a silane compound having an unsaturated bond with a hydroxyl group of the cellulose fiber. As another method, a method is also considered in which the unsaturated bond is introduced into the cellulose fiber by reacting a compound having a functional group (for example, a carboxylic acid anhydride group, an isocyanate group, or a silanol group) capable of efficiently reacting with the hydroxyl group in the cellulose fiber and one or more other functional groups with a compound having a functional group reactive with the compound and an unsaturated bond before or after reaction with the cellulose fiber. Among them, the modified cellulose fiber (A) having an unsaturated bond is preferably a reaction product of a carboxyl group-containing modified cellulose (E) and a compound (F) having an unsaturated bond and a glycidyl group.

The carboxyl group-containing modified cellulose (E) includes, for example, carboxymethyl cellulose, carboxyethyl cellulose, TEMPO oxidized cellulose and the like. In the present invention, the method for producing the carboxyl group-containing modified cellulose (E) is not particularly limited, however, since an amount of introduction of the unsaturated bond introduced in the subsequent reaction can be relatively easily adjusted and the production is easy, the carboxyl group-containing modified cellulose (E) obtained by reacting the polybasic acid anhydride (G) with the hydroxyl group of the cellulose fiber is preferable.

The polybasic acid anhydride (G) is not particularly limited, but includes maleic anhydride, fumaric anhydride, succinic anhydride, tetrahydrophthalic anhydride, hexahydrophthalic anhydride, alkyl or alkenyl succinic anhydride, and the like. In view of compatibility with the resin, a polybasic acid anhydride having eight or more carbon atoms is preferable, and tetrahydrophthalic anhydride, hexahydrophthalic anhydride, and alkyl or alkenyl succinic anhydride are more preferable. Particularly preferred are octenyl succinic anhydride, dodecenyl succinic anhydride, hexadecenyl succinic anhydride, and octadecenyl succinic anhydride.

Degree of substitution of the cellulose fiber obtained by reacting the polybasic acid anhydride (G) (when one hydroxyl group is substituted per glucose unit of the cellulose, the degree of substitution is represented by 1. Hereinafter, it is referred to as DS in some cases.) is preferably from 0.05 to 2.0, more preferably from 0.1 to 1.0, and still more preferably from 0.1 to 0.8. By setting the DS to 0.05 to 2.0, the amount of introduction of the unsaturated bond introduced by further reacting the compound (F) having an unsaturated bond and a glycidyl group is in a preferable range with respect to a mechanical strength of the molded foam obtained by foam molding.

Note that the DS in the present invention is obtained by conversion of mass increase rate after removal of the polybasic acid anhydride (G) used as the raw material and by-products such as hydrolyzate thereof by washing.

The compound (F) having an unsaturated bond and a glycidyl group includes phenyl glycidyl ether, allyl glycidyl ether, styrene oxide, cresyl glycidyl ether, glycidyl methacrylate, epoxy acrylate, butyl glycidyl ether acrylate and the like. Among these, the glycidyl methacrylate is preferable.

In addition to the compound (F) having an unsaturated bond and a glycidyl group, a compound (F′) having no unsaturated bond but a glycidyl group may be used in combination as long as effects of the present invention are not impaired. The amount of the compound (F′) can be used as long as it can consume all the carboxyl groups remaining after introducing the compound (F). The compound (F′) includes octylene oxide, methyl glycidyl ether, butyl glycidyl ether and the like.

When the carboxyl group is blocked with the compound (F) or the compound (F′) and an amount of carboxyl residue of the modified cellulose fiber (A) is reduced, thermal stability at the time of producing the molded foam is improved, and thus it is preferred that the number of carboxyl residues of the modified cellulose fiber (A) is preferably as small as possible.

<Thermoplastic Resin and/or Rubber (B)>

The thermoplastic resin and/or the rubber (B) used in the composition for a molded foam of the present invention is not particularly limited as long as it is commonly used as the resin for the foam molding material. The thermoplastic resins include: polyamide resins such as nylon; polyolefin resins such as polyethylene, polypropylene, ethylene-propylene copolymer and ethylene-vinyl acetate copolymer; polyester resins such as polyethylene terephthalate and polybutylene terephthalate; acrylic resins such as polymethyl methacrylate and polyethyl methacrylate; styrene resins such as polystyrene and (meth)acrylic ester-styrene resins; thermoplastic resins such as ionomer resins and cellulose resins; thermoplastic elastomer resins such as olefinic elastomer, vinyl chloride-based elastomer, styrene-based elastomer, urethane-based elastomer, polyester-based elastomer, polyamide-based elastomer; and a mixture of two or more of these resins. Preferred are polyolefin resin, polyester resin, acrylic resin, and styrene resin.

Rubber components include diene-based rubber components, and specifically include natural rubber, butadiene rubber, styrene-butadiene copolymer rubber, isoprene rubber, butyl rubber, acrylonitrile-butadiene rubber, acrylonitrile-styrene-butadiene copolymer rubber, chloroprene rubber, styrene-isoprene copolymer rubber, styrene-isoprene-butadiene copolymer rubber, isoprene-butadiene copolymer rubber, hydrogenated natural rubber, deproteinized natural rubber and the like. Rubber components other than the diene-based rubber components include ethylene-propylene copolymer rubber, nitrile rubber, acrylic rubber, epichlorohydrin rubber, polysulfide rubber, silicone rubber, fluorine rubber, urethane rubber, and a mixture of two or more of these rubbers. Preferred are natural rubber, butadiene rubber, styrene-butadiene copolymer rubber, isoprene rubber, ethylene-propylene copolymer rubber, and nitrile rubber.

### <Peroxide (C)>

The peroxide (C) used in the composition for a molded foam of the present invention may be any organic peroxide used as usual for addition polymerization of a vinyl compound. As the organic peroxide, alkyl peroxides and acyl peroxides can be used, and for example, they include dialkyl peroxides, diacyl peroxide, peroxy esters and the like, and specifically include t-butyl peroxy pivalate, dilauroyl peroxide, 1,1,3,3-tetramethylbutylperoxy-2-ethylhexanate, t-butylperoxy-2-ethylhexanate, dibenzoyl peroxide, t-butylperoxy laurate, dicumyl peroxide, di-t-hexyl peroxide and the like. Preferred is dicumyl peroxide.

### <Blowing Agent (D)>

The blowing agent (D) used in the composition for a molded foam of the present invention is a thermal decomposition type blowing agent, and includes an organic blowing agent and an inorganic blowing agent.

The organic blowing agents include nitroso compounds, azo compounds, sulfonyl hydrazide compounds, azide compounds and the like. The nitroso compounds include, for example, N, N′-dimethyl-N, N′-dinitrosoterephthalamide, N, N′-dinitrosopentamethylenetetramine and the like. The azo compounds include, for example, azodicarbonamide (ADCA), azobisformamide, azobisisobutyronitrile, azocyclohexylnitrile, azodiamino benzene, barium azodicarboxylate and the like. The sulfonyl hydrazide compounds include, for example, 4,4-oxybis (benzenesulfonylhydrazide), benzenesulfonylhydrazide, toluenesulfonylhydrazide, diphenylsulfone-3,3′-disulfonylhydrazide and the like. The azide compounds include, for example, calcium azide, 4,4′-diphenyl disulfonyl azide, p-toluene sulfonyl azide and the like.

The inorganic blowing agents include sodium hydrogen carbonate (sodium bicarbonate), sodium carbonate, ammonium hydrogen carbonate, ammonium carbonate, ammonium nitrite and the like. In the present invention, the organic blowing agent is preferable. Generally, one type of the blowing agent is used, but two or more types of the blowing agents may be contained. Preferred blowing agents include the azodicarbonamide (ADCA).

Incidentally, the azodicarbonamide is stable at room temperature, and when it reaches approximately 210° C. or more, a foaming gas containing nitrogen gas, carbon dioxide gas and carbon monoxide gas as main components is released to foam the resin. An azodicarbonamide-based blowing agent can also be used in addition to the azodicarbonamide. Specific examples of commercial products of the azodicarbonamide-based blowing agent include product names “Cell Mike CE”, “Cell Mike C-22”, “Cell Mike CAP-250” (all manufactured by Sankyo Kasei Co., Ltd.), “VINYFOR AC#3” (manufactured by Eiwa Chemical Ind. Co., Ltd.) and the like. These can be used alone or in combination of two or more. A content of the blowing agent is adjusted according to its type, a desired expansion ratio, and the like.

In addition to the peroxide (C), sulfur and a sulfur donor may be used in combination as long as the effects of the present invention are not impaired. Examples of sulfur and the sulfur donors include powdered sulfur, surface-treated sulfur, precipitated sulfur, colloidal sulfur, dithiodimorpholine, alkylphenol disulfide, thiuram disulfide, thiuram polysulfide and the like.

In addition to the above (A) to (D), other additives may be added as long as the effects of the present invention are not impaired. The other additives include, for example, thermally expandable microcapsules encapsulating a foaming aid, a compatibilizer, an inorganic filler, a pigment, an antioxidant, a flame retardant, a thermal stabilizer, or a hydrocarbon-based blowing agent, and beads impregnated with the hydrocarbon-based blowing agent, and can be blended in a composition for molding foam as required within a range not impairing the effects of the present invention.

The foaming aids include, for example, compounds having urea bonds or zinc compounds. The compounds having urea bonds include compounds such as urea, hydrazodicarbonamide, biuret, urazole having a urea bond (for example, —NHCONH₂, —NRCONH₂, —NHCONHR, —NRCONHR and the like; where R is an arbitrary group, preferably an organic group, more preferably an organic group having 1 to 10 carbon atoms, particularly preferably an alkyl group having 1 to 10 carbon atoms).

The zinc compounds include, oxides, hydroxides, carbonates, basic carbonates, sulfates, nitrates, phosphites and carboxylates of zinc, and the like. It is preferable to add the zinc compound in view of improving a foaming speed. The carboxylic acids constituting the carboxylates include, for example, aliphatic acids such as acetic acid, propionic acid, 2-ethylhexanoic acid, nonanoic acid, isononanoic acid, isodecanoic acid, neodecanoic acid, lauric acid, myristic acid, palmitic acid, stearic acid, isostearic acid, oleic acid, 12-hydroxystearic acid, ricinoleic acid, behenic acid and the like, and aromatic acids such as benzoic acid, p-tert-butylbenzoic acid, toluic acid, salicylic acid, naphthenic acid and the like. The carboxylates of zinc using the carboxylic acids may be in a form of either a normal salt, an acidic salt or a basic salt. As the carboxylic acids constituting the carboxylates of zinc, the above-mentioned ones can be used, however, aliphatic acids having 12 or more carbon atoms, which are powders at ordinary temperature, such as zinc stearate, zinc laurate and the like are preferable in view of reducing VOCs (volatile organic compounds). They are not liquid as in case of using other carboxylic acids, and can be preferably used since it is not necessary to dissolve them in an organic solvent in order to improve handling properties.

The compatibilizers include, for example, maleic anhydride, maleic anhydride modified polyethylene resin, maleic anhydride modified polypropylene resin and epoxy group-containing resin (such as glycidyl methacrylate and ethylene copolymer), and various commercially available compatibilizers may be used.

The composition for a molded foam of the present invention preferably has a mass ratio of the modified cellulose fiber (A)/the thermoplastic resin and/or the rubber (B)/the peroxide (C)/the blowing agent (D)=1 to 40/40 to 99/0.05 to 5/0.1 to 20.

When the above-mentioned optional sulfur, sulfur donors and the other additives are added to the composition for a molded foam of the present invention, it is preferable to use 10 parts by mass as an upper limit with respect to 100 parts by mass of the composition for a molded foam of the above-mentioned mass ratio.

### <Method for Producing Molded Foam>

The molded foam of the present invention can be obtained by foam molding the composition for molding foam. Specifically, by foam molding the modified cellulose fiber (A) having an unsaturated bond and the thermoplastic resin and/or the rubber (B) in the presence of the peroxide (C) and the blowing agent (D), the modified cellulose fiber (A) is reacted with the thermoplastic resin and/or the rubber (B). More preferably, the molded foam is obtained through the following steps:

(Step I) a step of heating and melt-kneading the modified cellulose fiber (A) and the thermoplastic resin and/or the rubber (B);
(Step II) a step of adding the peroxide (C) and the blowing agent (D) after Step I; and
(Step III) a step of foam molding after Step II.

In step I, the above (A) and the above (B) are mixed using a uniaxial or multi-axial kneader, or the like, and fiber components are finely dispersed uniformly in resin components. Even when the (A) before mixing is not previously fibrillated, the fiber component is sufficiently fibrillated in this mixing step. Further, before mixing the (A) and the (B), the (A) and the (B) which is powdered may be mixed in advance. By preliminary mixing, the (A) is more easily dispersed in the (B) during mixing. When mixing the (A) and the (B) which is powdered in advance, the (A) which is dried and the (B) which is dried and powdered may be mixed with a mixer or the like, or the (A) and the (B) which are powdered may be dispersed in a solvent which does not react with any of the (A) and the (B), and this dispersion liquid may be filtered and dried. In the production method of the present invention, the mixing is carried out using the uniaxial or multi-axial kneader, or the like, however, blending order of the raw materials, mixing temperature and melting timing in the mixing are not particularly limited. For example, the (A) and the (B) may be melted and kneaded, or the (B) may be melted in advance and the (A) may be mixed at the time of kneading. Kneading temperature in melt-kneading is preferably 70 to 240° C. in consideration of processability, and dispersion and deterioration of the modified cellulose fiber (A) and the plastic resin and/or the rubber (B). Further, a screw rotation speed of the uniaxial or multi-axial kneader is preferably in a range of 25 to 400 rpm in all steps.

Step II is a step of preparing the composition for molding foam. The composition for molding foam is obtained by adding the peroxide (C) and the blowing agent (D) after Step I. Note that a resin composition and the other additives as described above may be added in Step II and Step III described below as long as the effects of the present invention is not impaired.

The mixing is preferably kneading, and particularly melt-kneading in consideration of processing suitability (dispersibility, shortening of kneading time, suppression of decomposition of the blowing agent, and the like) of the composition for molding foam. Further, in the production method of the present invention, the mixing is carried out using a double roll or the like, however, the blending order of the raw materials, mixing temperature and melting timing in the mixing are not particularly limited. The kneading temperature in melt-kneading is preferably 70 to 180° C. in consideration of the processing suitability (dispersibility, shortening of kneading time, suppression of decomposition of the blowing agent, and the like) of the composition for molding foam.

In Step III, the composition for molding foam obtained in the above Step II is charged into a mold or the like and kept under heating and pressure, so that the modified cellulose fiber (A) having an unsaturated bond, the thermoplastic resin and/or the rubber (B), and the peroxide (C) in the composition for molding foam react. Then, the blowing agent (D) further undergoes decomposition by heat, and formed degradant is dissolved in the composition for molding foam. Thereafter, dissolved degradant of the blowing agent (D) is vaporized by decompression, so that the molded foam can be obtained.

Temperature in the pressure foaming step is preferably from 140 to 180° C. in consideration of the processing suitability (decomposition temperature of the blowing agent, suppression of fiber deterioration, and the like) of the composition for a molded foam.

In addition to the pressure foaming step as in the above Step III, a foam may be produced by the following methods.
An extrusion molding method in which a continuous molded body can be obtained while melting the composition for a molded foam under pressure by an extruder and while foaming it by extruding to atmospheric pressure from a die attached to a tip of the extruder
A short shot method including an injection step of injecting and filling the composition for a molded foam, which is in a molten state and in an amount less than a volume of a mold cavity, into the mold cavity and a foaming step of filling a void of the mold cavity by an inflation pressure by the blowing agent
A core back method in which the mold includes a fixed mold and a movable mold capable of advancing and retracting, and the core back method includes an injection step of injecting and filling the composition for a molded foam, which is in the molten state, into the mold cavity having a mold cavity clearance smaller than the mold cavity clearance corresponding to a shape position of a final product, and a foaming step of retracting the movable mold to the mold cavity clearance and filling the void of the mold cavity by the inflation pressure of the blowing agent

### <Modified Cellulose-Containing Resin Composition for Molded Foam>

Next, another embodiment for obtaining the molded foam of the present invention will be described. When using a modified cellulose fiber (A1) in which the modified cellulose fiber (A) is the reaction product of the carboxyl group-containing modified cellulose (E) and the compound (F) having an unsaturated bond and a glycidyl group, and the carboxyl group-containing modified cellulose (E) is a reaction product of the cellulose and the polybasic acid anhydride (G) having eight or more carbon atoms, the peroxide (C) and the blowing agent (D) are not always necessary, and even if the composition for a molded foam, which contains the modified cellulose fiber (A1), and the thermoplastic resin and/or the rubber (B), is foam molded by using sulfur and the sulfur donor instead of the peroxide (C) or by physical foaming by injecting a gas instead of the blowing agent (D) into a molding machine, it is possible to obtain the molded foam excellent in mechanical properties similarly to the molded foam produced by using the composition for a molded foam, which contains the modified cellulose fiber (A) having an unsaturated bond, the thermoplastic resin and/or the rubber (B), the peroxide (C) and the blowing agent (D).

The modified cellulose-containing resin composition for the molded foam of the present invention includes the modified cellulose fiber (A1) and the thermoplastic resin and/or the rubber (B). The modified cellulose-containing resin composition for the molded foam is preferably produced by mixing the modified cellulose fiber (A1) and the thermoplastic resin and/or the rubber (B) at the mass ratio of the (A1)/the (B)=1 to 40/40 to 99 in consideration of the processing suitability (dispersibility, shortening of kneading time, pelletization, and the like) of the composition for a molded foam, and the mechanical strength of the molded foam. In the production method of the present invention, the mixing of (A1) and (B) is preferably melt kneading.

The molded foam produced in this way can be used for various molded articles such as automobile parts, building material parts, industrial parts, toys and miscellaneous goods, sports and health parts, various sheets, films, other industrial goods, cushioning materials, packaging materials and the like.

### EXAMPLES

Hereinafter, Examples of the present invention will be described. It should be noted that the present invention is not limited to these examples. In Examples, “%” means “% by mass” unless otherwise specified.

### <Physical Property Value Measuring Method>

A physical property value measuring method used in some of these Examples are as follows.

### <1> Calculation of Hydroxyl Group Degree of Substitution (DS) of Carboxyl Group-Containing Modified Cellulose (E)

The degree of substitution DS of the carboxyl group-containing modified cellulose (E) was calculated from a mass increase rate before and after reaction after removal of a modifying agent used as the raw material and the by-products such as hydrolyzate thereof by washing, and was calculated from the following formula.

DS=(a/b)/(c/d)

a: (dry weight of the carboxyl group-containing modified cellulose (E))—(dry weight of the cellulose fiber)
b: molecular weight of the polybasic acid anhydride (G)
c: dry weight of the cellulose fiber
d: molecular weight (molecular weight 162) of glucose unit constituting the cellulose

### <2> Calculation of Double Bond Content (Iodine Value) of Modified Cellulose Fiber Having Unsaturated Bond

An amount of iodine reacting per 100 g of the modified cellulose fiber having an unsaturated bond was measured as the iodine value [12 (g)/fiber (100 g)] by the following procedure.

(1) 5 g of sample is precisely weighed and placed in Erlenmeyer flask.
(2) 50 g of NMP is added and stirred, and 10 mL of a Wijs reagent (acetic acid aqueous solution of iodine monochloride) and 50 g of ion exchange water are added.
(3) The sample is kept at room temperature in the dark for 30 minutes with occasional stirring.
(4) 20 mL of 10 mass % potassium iodide and 20 mL of ion exchange water are added, and titrated with 0.1 N sodium thiosulfate.
(5) When the color of the solution becomes pale, titration is continued by adding a starch indicator, and a titration amount of 0.1 N sodium thiosulfate when the color of the starch indicator disappears is read as an end point.
(6) Perform the same test without adding the sample, and make it a blank test.
(7) Calculate the iodine value by the following equation.

Iodine value of fiber [I2 (g)/fiber(100 g)]=(blank test titration amount−titration amount)×1.269/absolute dry fiber amount

### <3> Calculation of Number Average Fiber Diameter of Modified Cellulose in Modified Cellulose-Containing Resin Composition

The modified cellulose-containing resin composition was wrapped in a 325 mesh stainless steel mesh and treated under reflux of xylene at 140° C. for 5 hours to dissolve and remove the resin, to obtain a modified CNF. This was observed with an electron microscope and a width of the fiber was measured to calculate a number average fiber diameter of the modified CNF.

### <4> Measurement of Tensile Strength

A test piece having a length of 60 mm, a width of 10 mm, and a thickness of 4 mm was produced by cutting the molded foam obtained in Step (III) of the above <Method for producing molded foam>. The obtained test piece was subjected to tensile strength measurement using a tensile tester “TENSILON RTM-50” manufactured by Orientec Co., Ltd.

### <5> Measurement of Density

The mass in the air and the mass in water of the molded foam obtained in Step (III) of the above <Method for producing molded foam> were measured, and a density was determined by the Archimedes method, to be divided by a value of density of water to calculate the density.

### <6> Calculation of Specific Strength

A specific strength was calculated by dividing the tensile strength obtained in the above (2) by the density obtained in the above (4).

### <Production of Modified Cellulose Fiber>

### [Production Example of Carboxyl Group-Containing Modified Cellulose (E-1)]

500 parts by mass (solid content: 100 parts by mass) of needle leaf tree bleached kraft pulp (NBKP) containing water and 150 parts by mass of N-methylpyrrolidone (NMP) were charged in a container, water was distilled off by dehydration under reduced pressure, 19.9 parts by mass of hexadecenylsuccinic anhydride was added thereto, and the mixture was reacted at 80° C. for 4 hours. After the reaction, the NMP was distilled off by distillation under reduced pressure to obtain the carboxyl group-containing modified cellulose (E-1). The polybasic acid anhydride had the degree of substitution (DS) of 0.11 and the iodine value of 8. Incidentally, the (E-1) itself is also the modified cellulose fiber (A) having an unsaturated bond.

### [Production Example of Carboxyl Group-Containing Modified Cellulose (E-2)]

500 parts by mass (solid content: 100 parts by mass) of the NBKP containing water and 150 parts by mass of NMP were charged into a container, water was distilled off by dehydration under reduced pressure, 6.2 parts by mass of succinic anhydride was added thereto, and the mixture was reacted at 130° C. for 3 hours. After the reaction, the NMP was distilled off by distillation under reduced pressure to obtain the carboxyl group-containing modified cellulose (E-2). The polybasic acid anhydride had the degree of substitution (DS) of 0.12 and the iodine value of 0.

### [Production Example of Carboxyl Group-Containing Modified Cellulose (E-3)]

500 parts by mass (solid content: 100 parts by mass) of the NBKP containing water and 150 parts by mass of NMP were charged into a container, water was distilled off by dehydration under reduced pressure, 59.7 parts by mass of hexadecenylsuccinic anhydride was added thereto, and the mixture was reacted at 80° C. for 4 hours. After the reaction, the NMP was distilled off by distillation under reduced pressure to obtain the carboxyl group-containing modified cellulose (E-3). The polybasic acid anhydride had the degree of substitution (DS) of 0.29 and the iodine value of 15. Incidentally, the (E-3) itself is also the modified cellulose fiber (A) having an unsaturated bond.

### [Production Example of Carboxyl Group-Containing Modified Cellulose (E-4)]

500 parts by mass (solid content: 100 parts by mass) of the NBKP containing water and 150 parts by mass of NMP were charged into a container, water was distilled off by dehydration under reduced pressure, 9.5 parts by mass of 1,2,3,6-tetrahydrophthalic anhydride was added thereto, and the mixture was reacted at 130° C. for 3 hours. After the reaction, the NMP was distilled off by distillation under reduced pressure to obtain the carboxyl group-containing modified cellulose (E-4). The polybasic acid anhydride had the degree of substitution (DS) of 0.11 and the iodine value of 7.

### [Production Example of Carboxyl Group-Containing Modified Cellulose (E-5)]

500 parts by mass (solid content: 100 parts by mass) of the NBKP containing water and 150 parts by mass of NMP were charged into a container, water was distilled off by dehydration under reduced pressure, 9.6 parts by mass of hexahydrophthalic anhydride was added thereto, and the mixture was reacted at 130° C. for 3 hours. After the reaction, the NMP was distilled off by distillation under reduced pressure to obtain the carboxyl group-containing modified cellulose (E-5). The polybasic acid anhydride had the degree of substitution (DS) of 0.12 and the iodine value of 0.

TABLE 1

| | | | Degree of |
|---|---|---|---|
| | | | substitution |
| | | | (DS) of |
| | Type of | | polybasic |
| | pulp | Polybasic acid anhydride | acid anhydride |
| E-1 | NBKP | Hexadecenylsuccinic anhydride | 0.11 |
| E-2 | NBKP | Succinic anhydride | 0.12 |
| E-3 | NBKP | Hexadecenylsuccinic anhydride | 0.29 |
| E-4 | NBKP | 1,2,3,6-tetrahydrophthalic anhydride | 0.11 |
| E-5 | NBKP | Hexahydrophthalic anhydride | 0.12 |

### [Production Example of Modified Cellulose Fiber (A-1) Having Unsaturated Bond]

100 parts by mass (solid) of carboxyl group-containing modified cellulose (E-1) and 150 parts by mass of NMP were charged into a container, 6.7 parts by mass of butyl glycidyl ether was added thereto, and the mixture was reacted at 130° C. for 3 hours. After the reaction, the NMP was distilled off by distillation under reduced pressure to obtain the modified cellulose fiber (A-1) having an unsaturated bond. The iodine value was 7.

### [Production Example of Modified Cellulose Fiber (A-2) Having Unsaturated Bond]

100 parts by mass (solid) of carboxyl group-containing modified cellulose (E-1) and 150 parts by mass of NMP were charged into a container, 7.3 parts by mass of glycidyl methacrylate was added thereto, and the mixture was reacted at 130° C. for 3 hours. After the reaction, the NMP was distilled off by distillation under reduced pressure to obtain the modified cellulose fiber (A-2). The iodine value was 48.

### [Production Example of Modified Cellulose Fiber (A-3) Having Unsaturated Bond]

100 parts by mass (solid) of carboxyl group-containing modified cellulose (E-2) and 150 parts by mass of NMP were charged into a container, 8.3 parts by mass of glycidyl methacrylate was added thereto, and the mixture was reacted at 130° C. for 3 hours. After the reaction, the NMP was distilled off by distillation under reduced pressure to obtain the modified cellulose fiber (A-3) having an unsaturated bond. The iodine value was 53.

### [Production Example of Modified Cellulose Fiber (A-4) Having Unsaturated Bond]

100 parts by mass (solid) of carboxyl group-containing modified cellulose (E-3) and 150 parts by mass of NMP were charged into a container, 16.5 parts by mass of glycidyl methacrylate was added thereto, and the mixture was reacted at 130° C. for 3 hours. After the reaction, the NMP was distilled off by distillation under reduced pressure to obtain the modified cellulose fiber (A-4). The iodine value was 120.

### [Production Example of Modified Cellulose Fiber (A-5) Having Unsaturated Bond]

100 parts by mass (solid) of carboxyl group-containing modified cellulose (E-4) and 150 parts by mass of NMP were charged into a container, 8.0 parts by mass of glycidyl methacrylate was added thereto, and the mixture was reacted at 130° C. for 3 hours. After the reaction, the NMP was distilled off by distillation under reduced pressure to obtain the modified cellulose fiber (A-5). The iodine value was 47.

### [Production Example of Modified Cellulose Fiber (A-6) Having Unsaturated Bond]

100 parts by mass (solid) of carboxyl group-containing modified cellulose (E-1) and 150 parts by mass of NMP were charged into a container, 1.5 parts by mass of glycidyl methacrylate was added thereto, and the mixture was reacted at 130° C. for 3 hours. After the reaction, the NMP was distilled off by distillation under reduced pressure to obtain the modified cellulose fiber (A-6). The iodine value was 17.

### [Production Example of Modified Cellulose Fiber (A-7) Having Unsaturated Bond]

100 parts by mass (solid) of carboxyl group-containing modified cellulose (E-1) and 150 parts by mass of NMP were charged into a container, 3.7 parts by mass of glycidyl methacrylate was added thereto, and the mixture was reacted at 130° C. for 3 hours. After the reaction, the NMP was distilled off by distillation under reduced pressure to obtain the modified cellulose fiber (A-7). The iodine value was 26.

### [Production Example of Modified Cellulose Fiber (A-8) Having Unsaturated Bond]

100 parts by mass (solid) of carboxyl group-containing modified cellulose (E-1) and 150 parts by mass of NMP were charged into a container, 3.7 parts by mass of glycidyl methacrylate and 3.4 parts by mass of butyl glycidyl ether (in terms of molar ratio, glycidyl methacrylate:butyl glycidyl ether=1:1) were added thereto, and the mixture was reacted at 130° C. for 3 hours. After the reaction, the NMP was distilled off by distillation under reduced pressure to obtain the modified cellulose fiber (A-8). The iodine value was 16.

TABLE 2

| | Type of | | |
|---|---|---|---|
| | pulp | Compound having glycidyl group | Iodine value |
| A-1 | E-1 | Butyl glycidyl ether | 7 |
| A-2 | E-1 | Glycidyl methacrylate | 48 |
| A-3 | E-2 | Glycidyl methacrylate | 53 |
| A-4 | E-3 | Glycidyl methacrylate | 120 |
| A-5 | E-4 | Glycidyl methacrylate | 47 |
| A-6 | E-1 | Glycidyl methacrylate | 17 |
| A-7 | E-1 | Glycidyl methacrylate | 26 |
| A-8 | E-1 | Glycidyl methacrylate/butyl glycidyl ether | 16 |

### <Production of Modified Cellulose-Containing Resin Composition for Molded Foam: Step (I)>

### [Production Example of Modified Cellulose-Containing Resin Composition (R-1) for Molded Foam]

40 parts by mass of modified cellulose fiber (E-1) and 60 parts by mass of low density polyethylene (ULTZEX4020L manufactured by Prime Polymer Co., Ltd.) were kneaded at 140° C. with a twin-screw kneader (KZW, screw diameter: 15 mm, L/D: 45, screw rotation speed: 300 rpm, processing speed 200 g/hour) manufactured by Technovel Corporation, and the obtained melt-kneaded product was pelletized using a pelletizer (manufactured by Imoto Machinery Co., Ltd.) to obtain the modified cellulose-containing resin composition (R-1) for the molded foam in which the modified cellulose fiber contained therein was nanofibrillated. The number average fiber diameter was 220 nanometers.

### [Production Examples of Modified Cellulose-Containing Resin Compositions (R-2 to 9) for Molded Foam]

The modified cellulose-containing resin compositions (R-2 to 9) were produced in the same manner as the (R-1) except that the modified cellulose fiber (E-1) used for producing the modified cellulose-containing resin composition (R-1) for the molded foam was changed as shown in Table 3.

TABLE 3

| | Modified cellulose fiber (A) | | Thermoplastic resin and/or rubber (B) | |
|---|---|---|---|---|
| | Type | Parts by mass | Type | Parts by mass |
| R-1 | E-1 | 40 | ULTZEX4020L | 60 |
| R-2 | A-1 | 40 | ULTZEX4020L | 60 |
| R-3 | A-2 | 40 | ULTZEX4020L | 60 |
| R-4 | A-3 | 40 | ULTZEX4020L | 60 |
| R-5 | A-4 | 40 | ULTZEX4020L | 60 |
| R-6 | A-5 | 40 | ULTZEX4020L | 60 |
| R-7 | A-6 | 40 | ULTZEX4020L | 60 |
| R-8 | A-7 | 40 | ULTZEX4020L | 60 |
| R-9 | A-8 | 40 | ULTZEX4020L | 60 |

### <Production of Composition for Molding Foam: Step (II)>

### [Production Example of Composition (M-1) for Molding Foam]

A composition consisting of 6.0 parts by mass of the modified cellulose fiber (A-1), 83.0 parts by mass of low density polyethylene (ULTZEX4020L manufactured by Prime Polymer Co., Ltd.), 5.0 parts by mass of azodicarbonamide: ADCA (VINYFOR AC#3 manufactured by Eiwa Chemical Ind. Co., Ltd.), 5.0 parts by mass of zinc oxide (manufactured by Wako Pure Chemical Industries, Ltd.) and 1.0 part by mass of dicumyl peroxide (Percumyl D manufactured by NOF CORPORATION) was kneaded with a roll at 130° C. to obtain the composition (M-1) for molding foam in which the modified cellulose fiber contained therein was not nanofibrillated.

### [Production Example of Composition (M-2) for Molding Foam]

A composition consisting of 15.0 parts by mass of the modified cellulose-containing resin composition (R-1) for molding foam, 74.0 parts by mass of low density polyethylene (ULTZEX4020L manufactured by Prime Polymer Co., Ltd.), 5.0 parts by mass of azodicarbonamide: ADCA (VINYFOR AC#3 manufactured by Eiwa Chemical Ind. Co., Ltd.), 5.0 parts by mass of zinc oxide (manufactured by Wako Pure Chemical Industries, Ltd.) and 1.0 part by mass of dicumyl peroxide (Percumyl D manufactured by NOF CORPORATION) was kneaded with the roll at 130° C. to obtain the composition (M-2) for molding foam.

### [Production Examples of Compositions (M-3 to 11) for Molding Foam]

The compositions (M-3) to (M-11) for molding foam were obtained in the same manner as the (M-2) except that the modified cellulose-containing resin composition for molding foam which was used to produce the composition (M-2) for molding foam was changed as shown in Table 4.

TABLE 4

| | | | Modified | | | | | | | | | |
|---|---|---|---|---|---|---|---|---|---|---|---|---|
| | | | cellulose-containing | | Thermoplastic | | | | | | | |
| | Modified | | resin composition | | resin and/or | | | | | | | |
| | cellulose fiber | | for molded foam | | rubber (B) | | Peroxide | | Blowing agent | | Other additives | |
| | | Parts by | | Parts by | | Parts by | | Parts by | | Parts by | | Parts by |
| | Type | mass | Type | mass | Type | mass | Type | mass | Type | mass | Type | mass |
| M-1 | E-1 | 6.0 | — | — | ULTZEX | 83.0 | Dicumyl | 1 | Azodicarbonamide | 5 | Zinc oxide | 5 |
| | | | | | 4020L | | peroxide | | | | | |
| M-2 | — | — | R-1 | 15.0 | ULTZEX | 74.0 | Dicumyl | 1 | Azodicarbonamide | 5 | Zinc oxide | 5 |
| | | | | | 4020L | | peroxide | | | | | |
| M-3 | — | — | R-2 | 16.8 | ULTZEX | 72.2 | Dicumyl | 1 | Azodicarbonamide | 5 | Zinc oxide | 5 |
| | | | | | 4020L | | peroxide | | | | | |
| M-4 | — | — | R-3 | 16.1 | ULTZEX | 72.9 | Dicumyl | 1 | Azodicarbonamide | 5 | Zinc oxide | 5 |
| | | | | | 4020L | | peroxide | | | | | |
| M-5 | — | — | R-4 | 14.4 | ULTZEX | 74.6 | Dicumyl | 1 | Azodicarbonamide | 5 | Zinc oxide | 5 |
| | | | | | 4020L | | peroxide | | | | | |
| M-6 | — | — | R-5 | 23.3 | ULTZEX | 65.7 | Dicumyl | 1 | Azodicarbonamide | 5 | Zinc oxide | 5 |
| | | | | | 4020L | | peroxide | | | | | |
| M-7 | — | — | R-6 | 18.2 | ULTZEX | 70.8 | Dicumyl | 1 | Azodicarbonamide | 5 | Zinc oxide | 5 |
| | | | | | 4020L | | peroxide | | | | | |
| M-8 | — | — | R-7 | 15.2 | ULTZEX | 73.8 | Dicumyl | 1 | Azodicarbonamide | 5 | Zinc oxide | 5 |
| | | | | | 4020L | | peroxide | | | | | |
| M-9 | — | — | R-4 | 9.7 | ULTZEX | 79.3 | Dicumyl | 1 | Azodicarbonamide | 5 | Zinc oxide | 5 |
| | | | | | 4020L | | peroxide | | | | | |
| M-10 | — | — | R-8 | 15.5 | ULTZEX | 73.5 | Dicumyl | 1 | Azodicarbonamide | 5 | Zinc oxide | 5 |
| | | | | | 4020L | | peroxide | | | | | |
| M-11 | — | — | R-9 | 16.1 | ULTZEX | 72.9 | Dicumyl | 1 | Azodicarbonamide | 5 | Zinc oxide | 5 |
| | | | | | 4020L | | peroxide | | | | | |

The mass ratio of the modified cellulose fiber (A), the thermoplastic resin and/or the rubber (B), the peroxide (C), the foaming agent (D) and the other additives of the compositions (M-1) to (M-11) for molding foam is shown in Table 5.

TABLE 5

| | Modified | | Thermoplastic | | | | | | | |
|---|---|---|---|---|---|---|---|---|---|---|
| | cellulose fiber | | resin and/or | | | | | | | |
| | (A) | | rubber (B) | | Peroxide (C) | | Blowing agent (D) | | Other additives | |
| | | Parts by | | Parts by | | Parts by | | Parts by | | Parts by |
| | Type | mass | Type | mass | Type | mass | Type | mass | Type | mass |
| M-1 | E-1 | 6.0 | ULTZEX4020L | 83.0 | Dicumyl | 1 | Azodicarbonamide | 5 | Zinc oxide | 5 |
| | | | | | peroxide | | | | | |
| M-2 | E-1 | 6.0 | ULTZEX4020L | 83.0 | Dicumyl | 1 | Azodicarbonamide | 5 | Zinc oxide | 5 |
| | | | | | peroxide | | | | | |
| M-3 | A-1 | 6.7 | ULTZEX4020L | 82.3 | Dicumyl | 1 | Azodicarbonamide | 5 | Zinc oxide | 5 |
| | | | | | peroxide | | | | | |
| M-4 | A-2 | 6.4 | ULTZEX4020L | 82.6 | Dicumyl | 1 | Azodicarbonamide | 5 | Zinc oxide | 5 |
| | | | | | peroxide | | | | | |
| M-5 | A-3 | 5.8 | ULTZEX4020L | 83.2 | Dicumyl | 1 | Azodicarbonamide | 5 | Zinc oxide | 5 |
| | | | | | peroxide | | | | | |
| M-6 | A-4 | 9.3 | ULTZEX4020L | 79.7 | Dicumyl | 1 | Azodicarbonamide | 5 | Zinc oxide | 5 |
| | | | | | peroxide | | | | | |
| M-7 | A-5 | 7.3 | ULTZEX4020L | 81.7 | Dicumyl | 1 | Azodicarbonamide | 5 | Zinc oxide | 5 |
| | | | | | peroxide | | | | | |
| M-8 | A-6 | 6.1 | ULTZEX4020L | 82.9 | Dicumyl | 1 | Azodicarbonamide | 5 | Zinc oxide | 5 |
| | | | | | peroxide | | | | | |
| M-9 | A-3 | 3.9 | ULTZEX4020L | 85.1 | Dicumyl | 1 | Azodicarbonamide | 5 | Zinc oxide | 5 |
| | | | | | peroxide | | | | | |
| M-10 | A-7 | 6.2 | ULTZEX4020L | 82.8 | Dicumyl | 1 | Azodicarbonamide | 5 | Zinc oxide | 5 |
| | | | | | peroxide | | | | | |
| M-11 | A-8 | 6.4 | ULTZEX4020L | 82.6 | Dicumyl | 1 | Azodicarbonamide | 5 | Zinc oxide | 5 |
| | | | | | peroxide | | | | | |

### [Comparative Production Example of Composition (RM-1) for Molding Foam]

A composition consisting of 89.0 parts by mass of low density polyethylene (ULTZEX4020L manufactured by Prime Polymer Co., Ltd.), 5.0 parts by mass of azodicarbonamide: ADCA (VINYFOR AC#3 manufactured by Eiwa Chemical Ind. Co., Ltd.), 5.0 parts by mass of zinc oxide (manufactured by Wako Pure Chemical Industries, Ltd.) and 1.0 part by mass of dicumyl peroxide (Percumyl D manufactured by NOF CORPORATION) was kneaded with the roll at 130° C. to obtain the composition (RM-1) for molding foam.

### [Comparative Production Example of Composition (RM-2) for Molding Foam]

A composition consisting of 5.0 parts by mass of NBKP, 84.0 parts by mass of low density polyethylene (ULTZEX4020L manufactured by Prime Polymer Co., Ltd.), 5.0 parts by mass of azodicarbonamide: ADCA (VINYFOR AC#3 manufactured by Eiwa Chemical Ind. Co., Ltd.), 5.0 parts by mass of zinc oxide (manufactured by Wako Pure Chemical Industries, Ltd.) and 1.0 part by mass of dicumyl peroxide (Percumyl D manufactured by NOF CORPORATION) was kneaded with the roll at 130° C. to obtain the composition (RM-2) for molding foam.

### [Comparative Production Example of Composition (RM-3) for Molding Foam]

A composition consisting of 5.6 parts by mass of the carboxyl group-containing modified cellulose (E-5), 83.4 parts by mass of low density polyethylene (ULTZEX4020L manufactured by Prime Polymer Co., Ltd.), 5.0 parts by mass of azodicarbonamide: ADCA (VINYFOR AC#3 manufactured by Eiwa Chemical Ind. Co., Ltd.), 5.0 parts by mass of zinc oxide (manufactured by Wako Pure Chemical Industries, Ltd.) and 1.0 part by mass of dicumyl peroxide (Percumyl D manufactured by NOF CORPORATION) was kneaded with the roll at 130° C. to obtain the composition (RM-3) for molding foam.

### [Production Example of Composition (RM-4) for Molding Foam]

A composition consisting of 15.0 parts by mass of the modified cellulose-containing resin composition (R-1) for the molded foam, 75.0 parts by mass of low density polyethylene (ULTZEX4020L manufactured by Prime Polymer Co., Ltd.), 5.0 parts by mass of azodicarbonamide: ADCA (VINYFOR AC#3 manufactured by Eiwa Chemical Ind. Co., Ltd.), and 5.0 parts by mass of zinc oxide (manufactured by Wako Pure Chemical Industries, Ltd.) was kneaded with the roll at 130° C. to obtain the composition (RM-4) for molding foam.

TABLE 6

| | (Modified) Cellulose | | | | | | | | | |
|---|---|---|---|---|---|---|---|---|---|---|
| | fiber (containing resin | | Thermoplastic resin and/or | | | | | | | |
| | composition) | | rubber (B) | | Peroxide (C) | | Blowing agent (D) | | Other additives | |
| | | Parts by | | Parts by | | Parts by | | Parts by | | Parts by |
| | Type | mass | Type | mass | Type | mass | Type | mass | Type | mass |
| RM-1 | — | — | ULTZEX4020L | 89.0 | Dicumyl | 1 | Azodicarbonamide | 5 | Zinc | 5 |
| | | | | | peroxide | | | | oxide | |
| RM-2 | NBKP | 5 | ULTZEX4020L | 84.0 | Dicumyl | 1 | Azodicarbonamide | 5 | Zinc | 5 |
| | | | | | peroxide | | | | oxide | |
| RM-3 | E-5 | 5.6 | ULTZEX4020L | 83.4 | Dicumyl | 1 | Azodicarbonamide | 5 | Zinc | 5 |
| | | | | | peroxide | | | | oxide | |
| RM-4 | R-1 | 15 | ULTZEX4020L | 75.0 | — | — | Azodicarbonamide | 5 | Zinc | 5 |
| | | | | | | | | | oxide | |

### <Pressure Foaming: Step (III)>

### Example 1

The composition for molding foam obtained in the composition (M-1) for molding foam was filled in a metal mold in a press heated to 160° C. and kept under pressure for 25 minutes to obtain the molded foam. The density was 0.10 g/cm³.

### Examples 2 to 11, Reference Example 1, Comparative Examples 1 to 3

The molded foams were obtained in the same manner as in Example 1 except that the composition (M-1) for molding foam of the foam (Example 1) was changed to types as shown in Table 7. Comparative Example 3 is an example in which the foam molding was carried out under a condition that there was no peroxide, and the modified cellulose fiber (A) having an unsaturated bond was not the reaction product of the carboxyl group-containing modified cellulose (E) and the compound (F) having an unsaturated bond and a glycidyl group. In this case, gas as a decomposition product of the blowing agent escaped during foam molding, and the foam could not be obtained (therefore, the density was not measured).

TABLE 7

| | Composition for molded foam | Density |
|---|---|---|
| | Type | g/cm³ |
| Example 1 | M-1 | 0.10 |
| Example 2 | M-2 | 0.11 |
| Example 3 | M-3 | 0.09 |
| Example 4 | M-4 | 0.09 |
| Example 5 | M-5 | 0.09 |
| Example 6 | M-6 | 0.08 |
| Example 7 | M-7 | 0.08 |
| Example 8 | M-8 | 0.11 |
| Example 9 | M-9 | 0.10 |
| Example 10 | M-10 | 0.10 |
| Example 11 | M-11 | 0.11 |
| Reference Example 1 | RM-1 | 0.11 |
| Comparative Example 1 | RM-2 | 0.10 |
| Comparative Example 2 | RM-3 | 0.11 |
| Comparative Example 3 | RM-4 | — |

### [Evaluation of Physical Properties of Molded Foam]

Physical properties (specific strength in a tensile test) of the molded foams obtained in Examples 1 to 11, Reference Example 1, and Comparative Examples 1 and 2 are shown in Table 8.

TABLE 8

| | | | Degree of | | | |
|---|---|---|---|---|---|---|
| | | | substitution | | | Specific |
| | Ratio of | Polybasic acid | (DS) of Polybasic acid | Compound having | Fibrillation | strength |
| | fiber (%) | anhydride | anhydride | glycidyl group | treatment | (MPa) |
| Example 1 | 5 | Hexadecenyl succinic | 0.11 | — | No | 14.3 |
| | | anhydride | | | | |
| Example 2 | 5 | Hexadecenyl succinic | 0.11 | — | Yes | 15.1 |
| | | anhydride | | | | |
| Example 3 | 5 | Hexadecenyl succinic | 0.11 | Butyl glycidyl ether | Yes | 15.3 |
| | | anhydride | | | | |
| Example 4 | 5 | Hexadecenyl succinic | 0.11 | Glycidyl | Yes | 16.9 |
| | | anhydride | | methacrylate | | |
| Example 5 | 5 | Succinic anhydride | 0.11 | Glycidyl | Yes | 15.2 |
| | | | | methacrylate | | |
| Example 6 | 5 | Hexadecenyl succinic | 0.29 | Glycidyl | Yes | 16.1 |
| | | anhydride | | methacrylate | | |
| Example 7 | 5 | 1,2,3,6-tetrahydrophthalic | 0.11 | Glycidyl | Yes | 18.4 |
| | | anhydride | | methacrylate | | |
| Example 8 | 5 | Hexadecenyl succinic | 0.11 | Glycidyl | Yes | 16.0 |
| | | anhydride | | methacrylate | | |
| Example 9 | 3 | Succinic anhydride | 0.11 | Glycidyl | Yes | 16.1 |
| | | | | methacrylate | | |
| Example 10 | 5 | Hexadecenyl succinic | 0.11 | Glycidyl | Yes | 16.4 |
| | | anhydride | | methacrylate | | |
| Example 11 | 5 | Hexadecenyl succinic | 0.11 | Glycidyl | Yes | 16.6 |
| | | anhydride | | methacrylate/ | | |
| | | | | Butyl glycidyl ether | | |
| Reference Example 1 | 0 | — | — | — | No | 13.4 |
| Comparative Example 1 | 5 | — | — | — | No | 13.6 |
| Comparative Example 2 | 5 | Hexahydrophthalic | 0.12 | — | No | 14.0 |
| | | anhydride | | | | |

From Table 8 of the examples, it is understood that specific strengths of the obtained molded foams in Examples 1 to 11 using the molded foams satisfying the present invention are increased as compared with Comparative Examples 1 and 2. Further, it is understood from Examples 1 and 2 that the specific strength is improved by using the modified cellulose-containing resin composition for the molded foam. It is understood from Examples 2 and 4 that the specific strength is increased by using the modified cellulose fiber (A) which is the reaction product of the carboxyl group-containing modified cellulose (E) and the compound (F) having an unsaturated bond and a glycidyl group. By comparing Examples 4 and 5, it is understood that the specific strength is increased by using the polybasic acid anhydride having eight or more carbon atoms as the polybasic acid anhydride (G).

1. A composition for a molded foam, comprising:
a modified cellulose fiber (A) having an unsaturated bond;
a thermoplastic resin and/or a rubber (B);
a peroxide (C); and
a blowing agent (D).

2. The composition for a molded foam according to claim 1, wherein the modified cellulose fiber (A) is a nanofibrillated material.

3. The composition for a molded foam according to claim 1, wherein the modified cellulose fiber (A) is a reaction product of a carboxyl group-containing modified cellulose (E) and a compound (F) having an unsaturated bond and a glycidyl group.

4. The composition for a molded foam according to claim 3, wherein the carboxyl group-containing modified cellulose (E) is a reaction product of cellulose and polybasic acid anhydride (G).

5. The composition for a molded foam according to claim 4, wherein the polybasic acid anhydride (G) is the polybasic acid anhydride having eight or more carbon atoms.

6. The composition for a molded foam according to claim 1, wherein the thermoplastic resin of the above (B) is at least one selected from polyolefin-based resin, polyester-based resin, acrylic resin and styrene resin.

7. The composition for a molded foam according to claim 1, wherein a mass ratio of the modified cellulose fiber (A)/the thermoplastic resin and/or the rubber (B)/the peroxide (C)/the blowing agent (D)=1 to 40/40 to 99/0.05 to 5/0.1 to 20.

8. A molded foam using the composition for a molded foam according to claim 1 as a raw material.

9. A method for producing a composition for a molded foam, comprising:
a modified cellulose fiber (A) having an unsaturated bond;
a thermoplastic resin and/or a rubber (B);
a peroxide (C); and
a blowing agent (D), wherein
the modified cellulose fiber (A) having an unsaturated bond is obtained by reacting a carboxyl group-containing modified cellulose (E) with a compound (F) having an unsaturated bond and a glycidyl group.

10. The method for producing a composition for a molded foam according to claim 9, wherein the modified cellulose fiber (A) is a modified cellulose fiber obtained by reacting cellulose with polybasic acid anhydride (G) to obtain the carboxyl group-containing modified cellulose (E) and then further reacting the compound (F) having an unsaturated bond and a glycidyl group.

11. The method for producing a composition for a molded foam according to claim 10, wherein the polybasic acid anhydride (G) is the polybasic acid anhydride having eight or more carbon atoms.

12. A method for producing a molded foam, wherein a modified cellulose fiber (A) having an unsaturated bond and a thermoplastic resin and/or a rubber (B) are foam molded in the presence of a peroxide (C) and a blowing agent (D), so that the modified cellulose fiber (A) and the thermoplastic resin and/or the rubber (B) are reacted.

13. The method for producing a molded foam according to claim 12, comprising following steps:
(Step I) a step of heating and melt-kneading the modified cellulose fiber (A) and the thermoplastic resin and/or the rubber (B) to nanofibrillate the modified cellulose fiber (A);
(Step II) a step of adding the peroxide (C) and the blowing agent (D) after Step I; and
(Step III) a step of foam molding after Step II.

14. A modified cellulose-containing resin composition for a molded foam, comprising:
a modified cellulose fiber (A) having an unsaturated bond; and
a thermoplastic resin and/or a rubber (B), wherein
the modified cellulose fiber (A) having an unsaturated bond is a reaction product of a carboxyl group-containing modified cellulose (E) and a compound (F) having an unsaturated bond and a glycidyl group, and
the carboxyl group-containing modified cellulose (E) is a reaction product of cellulose and a polybasic acid anhydride (G) having eight or more carbon atoms.

15. The modified cellulose-containing resin composition for a molded foam according to claim 14, wherein the modified cellulose fiber (A) is a nanofibrillated material.

16. The modified cellulose-containing resin composition for a molded foam according to claim 14, wherein the thermoplastic resin is at least one selected from polyolefin-based resin, polyester-based resin, acrylic resin and styrene resin.

17. The composition for a molded foam according to claim 14, wherein a mass ratio of the modified cellulose fiber (A)/the thermoplastic resin and/or the rubber (B)=1 to 40/40 to 99.

18. A molded foam using the modified cellulose-containing resin composition for a molded foam according to claim 14 as a raw material.
